(19) United States
(12) Patent Application Publication
(10) Pub. No.: US 2004/0105362 A1
(43) Pub. Date: Jun. 3, 2004

(54) Disk device and risk processing method

(75) Inventor: Takeshi Nakano, Hamura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/721,174

(22) Filed: Nov. 26, 2003

(30) Foreign Application Priority Data
Nov. 29, 2002 (JP) 2002-348707

(51) Int. Cl. G11B 7/095

(52) U.S. Cl. 369/44.36; 369/44.41; 369/53.22

(57) ABSTRACT

There is provided a disk device including a detector section which generates detection signals according to reflected lights of laser lights emitted on a disk, a removing section which detects detrack components which have failed to detect recording information on the disk from the detection signals and removes and outputs the same from the detection signals, and a processing section which applies a predetermined processing on the basis of signals obtained by removing detrack components from the detection signals, so that erroneous address information on CAPA which has been failed to read or the like can be removed, thereby improving reading accuracy of the disk.

### CROSS-REFERENCE TO RELATED APPLICATIONS

This application is based upon and claims the benefit of priority from the prior Japanese Patent Application No. 2002-348707, filed Nov. 29, 2002, the entire contents of which are incorporated herein by reference.

### BACKGROUND OF THE INVENTION

1. Field of the Invention

The present invention relates to a disk device and a disk processing method, and particularly to a disk device and a disk processing method for eliminating reading failure of CAPA (Complimentary Allocated Pit Address) or the like to improve reading accuracy.

2. Description of the Related Art

In recent years, as development and distribution of an optical disk or an optical disk device are advanced, the optical disk is made larger in capacity and high operation reliability is accordingly desired for a control system of the optical disk device.

In an optical disk recording/reproducing device, in a media for recording pits both in a land and in a groove represented by DVD-RAM, ID (Identification Data) of CAPA (Complimentary Allocated Pit Address) arranged in a staggered manner with respect to pit strings is read to acquire information on whether an address and a currently traced pit string are in the land or in the groove. Thus, when this ID reading performance is deteriorated, address information which is being traced is lacked so that the reading performance is remarkably deteriorated.

With respect to this, as a conventional technique for improving reading accuracy, there is disclosed an optical disk and an optical disk device for increasing detection accuracy by a configuration, arrangement and the like of four PID in a prepit area. Here, a length and a time of VFO in a header area, a length of a mirror area provided between information recording areas; and the like are appropriately selected, thereby improving reading accuracy.

However, for example, since CAPA arranged in DVD-RAM is arranged in a staggered manner with respect to pit strings, a header of CAPA is shifted and arranged at a position ½ detracked relative to a traced beam. Therefore, when reflected lights are received in a quartered detector and four detection signals are output, a signal according to address information from CAPA can be acquired in the detection signal (A+D) in a detector at a side to which the header is shifted, but a reflected light from the header cannot be sufficiently acquired in the detection signal (B+C) at a side where a header is not present, so that accurate address information on CAPA cannot be acquired. Further, since a strong reflected light from the disk face is received so that a detection signal is increased, a response speed of a slice potential for binarizing a detection signal is not in time, which causes deterioration in an error rate. Such a problem has been increased according to reduction in a diameter of a beam spot along with high density of an optical disk. Therefore, error components may be included in the detection signals with respect to CAPA of DVD-RAM at a position shifted from a track axis where an optical beam passes or a prepit of DVD-R or RW, so that there is a problem that accurate address control or data reading cannot be performed.

### BRIEF SUMMARY OF THE INVENTION

One embodiment according to the present invention provides a disk device comprises a detector section which detects detection signals from reflected lights of laser lights emitted on a disk, the detection signals includes detrack components, which is failed to correctly detected by the detector section; a removing section which detects the detrack components, and removes the same from the detection signals; and a processing section which applies a predetermined processing on the detection signals removed detrack components by the removing section.

### BRIEF DESCRIPTION OF THE SEVERAL VIEWS OF THE DRAWING

FIG. 1 is a block diagram showing one example of a configuration of an optical disk device according to the present invention;

FIG. 2 is a block diagram showing one example of a configuration of an optical system of the optical disk device according to the present invention;

FIG. 3 is a block diagram showing one example of a detrack detecting/removing section (RAM compliant, filters) according to the present invention;

FIG. 4 is a block diagram showing another example of the detrack detecting/removing section (RAM compliant, switches) according to the present invention;

FIG. 5 is a block diagram showing another example of the detrack detecting/removing section (R or RW compliant, filter) according to the present invention;

FIG. 6 is a block diagram showing another example of the detrack detecting/removing section (R or RW compliant, switch) according to the present invention;

FIG. 7 is a block diagram showing another example of the detrack detecting/removing section (versatile, filters) according to the present invention;

FIG. 8 is a block diagram showing another example of the detrack detecting/removing section (versatile, switches) according to the present invention;

FIG. 9 is a block diagram showing another example of the detrack detecting/removing section (control signals, filters) according to the present invention;

FIG. 10 is a block diagram showing another example of the detrack detecting/removing section (control signals, switches) according to the present invention;

FIG. 11 is a diagram showing one example of detector outputs during CAPA passing of the optical disk device according to the present invention;

FIG. 12 is an enlarged diagram showing one example of the detector outputs during CAPA passing of the optical disk device according to the present invention;

FIG. 13 is a graph showing effects expressed by the optical disk device according to the present invention;

FIG. 14 is a diagrams showing a CAPA configuration of a DVD-RAM disk which indicates detracks to be handled by the detrack detecting/removing section of the optical disk device according to the present invention;

FIG. 15 is a diagram showing a configuration of a DVD-R or RW disk which indicates a detrack to be handled by the detrack detecting/removing section of the optical disk device according to the present invention; and

FIG. 16 is a flow chart for explaining one example of a detrack removing processing of the optical disk device according to the present invention.

### DETAILED DESCRIPTION OF THE INVENTION

Hereinafter, one example of an optical disk device according to one embodiment of the present invention will be described in detail with reference to the drawings.

<Configuration and Operation of Optical Disk Device>

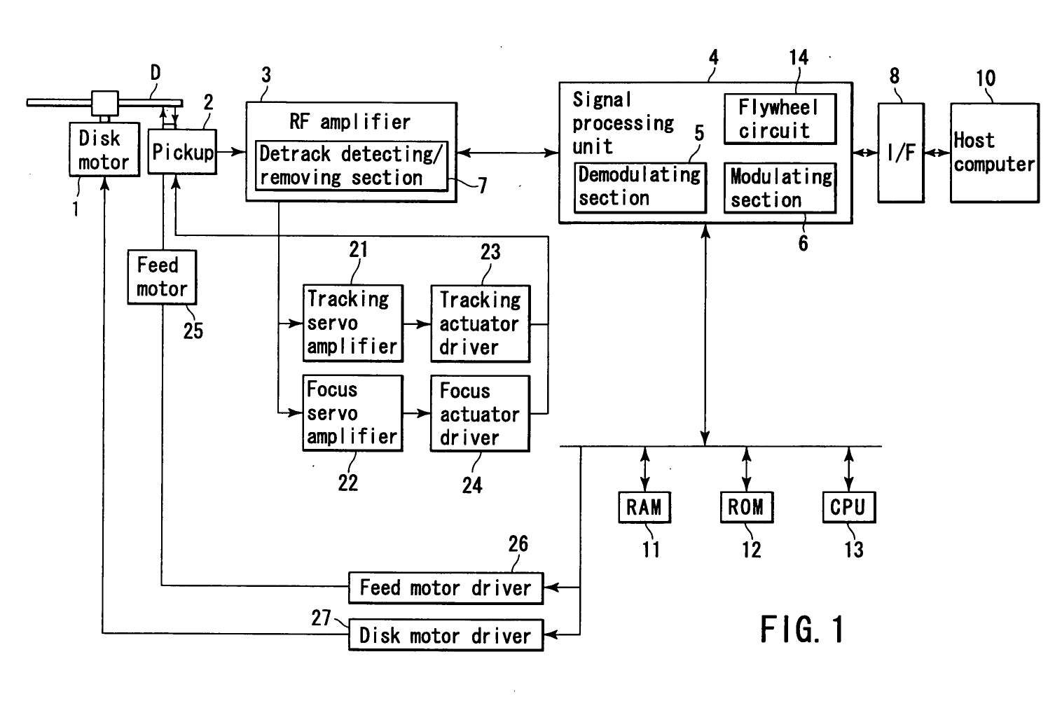

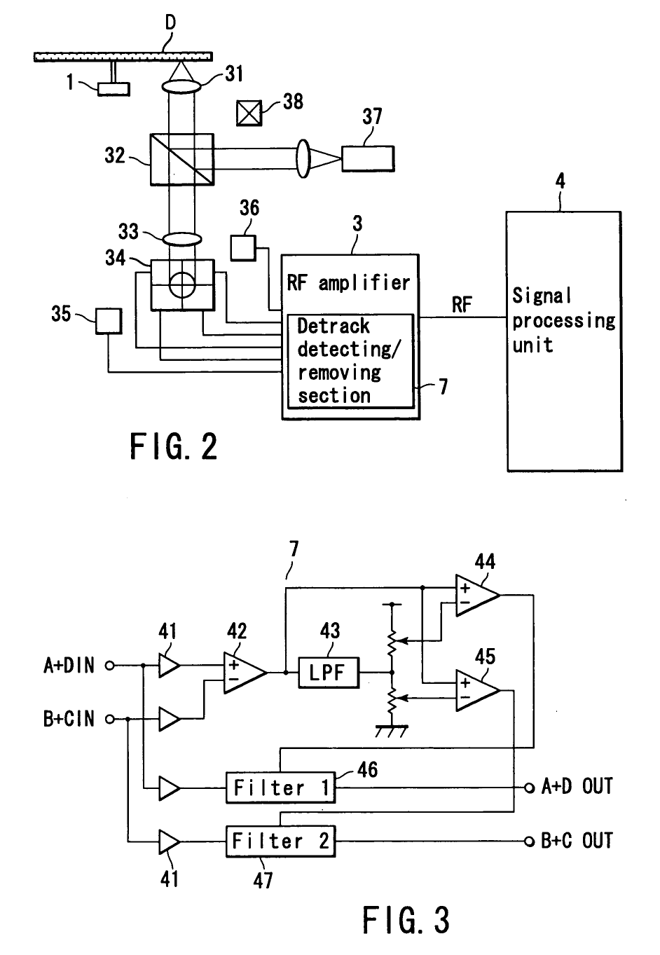

At first, a configuration of the optical disk device according to the present invention will be described with reference to the drawings. FIG. 1 is a block diagram showing one example of the configuration of the optical disk device according to the present invention, and FIG. 2 is a block diagram showing one example of a configuration of an optical system thereof.

(Configuration)

As shown in FIGS. 1 and 2, the optical disk device according to the present invention has an optical pickup 2 for emitting a laser light on a disk D driven by a disk motor 1 or receiving a reflected light thereof, and a RF amplifier 3 to which a read signal in the pickup 2 is supplied. The optical disk device further has a signal processing unit 4 to which a RF signal amplified in the RF amplifier 3 is supplied. Here, the RF amplifier 3 includes a detrack detecting/removing section 7 according to the present invention. The optical disk device further has a tracking servo amplifier 21 and a focus servo amplifier 22 which are connected to the RF amplifier 3 and to which a focus error signal FE and a tacking error signal TE are supplied, respectively, and a tracking actuator driver 23 and a focus actuator driver 24 which are connected thereto, respectively. An output of each driver 23, 24 is returned to the pickup 2 to be supplied to a drive coil 38 in a track direction and a drive coil in a focus direction (not shown) for servo control. Further, the optical disk device has a disk motor driver 27 connected to control sections thereof, the disk motor 1 connected thereto, a feed motor driver 26, and a feed motor 25 connected thereto.

The signal processing unit 4 has a demodulating section 5, a modulating section 6, a flywheel circuit 14 for supplying control signals C1 and C2 to the detrack detecting/removing section 7 according to the present invention.

Further, as shown in FIG. 2, the pickup 2 connected to the RF amplifier 3 has a quartered detector 34 and sub-beam detectors 35, 36, and further a laser generator 37 for generating a laser light to be emitted on an optical disk, a splitter 32 for separating a generated laser light and a reflected light from the optical disk D, a objective lens 31, and a composite lens 33 disposed in front of the quartered detector 34.

(Operation)

A processing operation of the optical disk D is performed in the optical disk device having such a configuration according to the present invention as described later. In other words, as shown in FIG. 1, a signal read by the optical pickup 2 from the disk D driven by the disk motor 1 is supplied to the RF amplifier 3. The RF amplifier 3 supplies a RF signal amplified from the output of the optical pickup 2 to the demodulating section 5 of the signal processing unit 4. Further, the RF amplifier 3 extracts a focus error signal FE and a tracking error signal TE and supplies them to the tracking servo amplifier 21 and the focus servo amplifier 22, respectively. Furthermore, a control signal supplied from the tracking servo amplifier 21 is supplied to the tracking actuator driver 23, and a control signal supplied from the focus servo amplifier is output to the focus actuator driver 24. The output of each driver 23, 24 is returned to the pickup 2 and supplied to the drive coil 38 in the tracking direction and the drive coil in the focus direction (not shown) to drive the coils and perform the servo control in the tracking direction and in the focus direction.

The signal processing unit 4 comprises the demodulating section 5 and the modulating section 6, and the demodulating section 5 demodulates a signal which is detected by the optical pickup 2 and is appropriately amplified by the RF amplifier 3 to be supplied into a reproducible signal form under control of the control sections such as a CPU 13, a RAM 11, and a ROM 12. The demodulated signal is supplied to a processing device such as, for example, an external host computer via an interface 8.

The modulating section 6 which the signal processing unit 4 has modulates a signal given from, for example, a host computer 10 or the like via the interface 8 into a signal form recordable into the optical disk D. The modulated signal is reflected on a laser light which is generated from a semiconductor laser 35 described later of the pickup 2 via the RF amplifier 3 to be emitted in a predetermined area of the optical disk, and is recorded in the predetermined area as reproducible information.

The control sections make an operation determination by the CPU 13 according to operation programs stored in the RAM 11 and the ROM 12, and controls the entire processing operation by referring to information from each unit. The interface 8 performs communication control relating to the interface such as transmission/reception of various operation instructions and data with the host computer 10. An operation instruction is exchanged between the control sections and the host computer 10 via the interface 8. However, the optical disk device may be operated by an operation panel (not shown), and is not particularly limited to this form.

(Operation of Detrack Detecting/Removing Section According to the Present Invention)

An operation of the detrack detecting/removing section which is a characteristic of the present invention will be described in detail in the above optical disk device with reference to the drawings. FIGS. 3 to 10 are block diagrams showing respective embodiments of the detrack detecting/removing section according to the present invention.

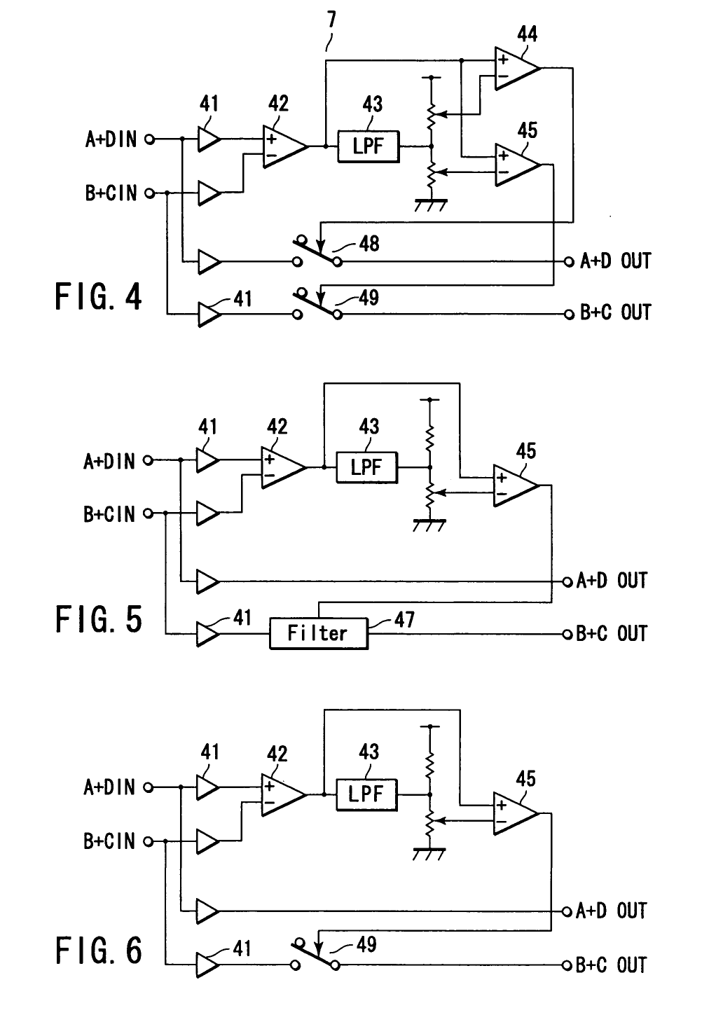

In these drawings, a detrack component removing processing according to the present invention is mainly performed by the detrack detecting/removing section incorporated in the RF amplifier 3. Here, the outline thereof will be described. FIGS. 3 and 4 shows embodiments compliant with DVD-RAM, where detracks are removed using filters in FIG. 3 and using switches in FIG. 4.

Further, FIGS. 5 and 6 shows embodiments compliant with DVD-R or DVD-RW, where a detrack is removed using a filter in FIG. 5 or using a switch in FIG. 6.

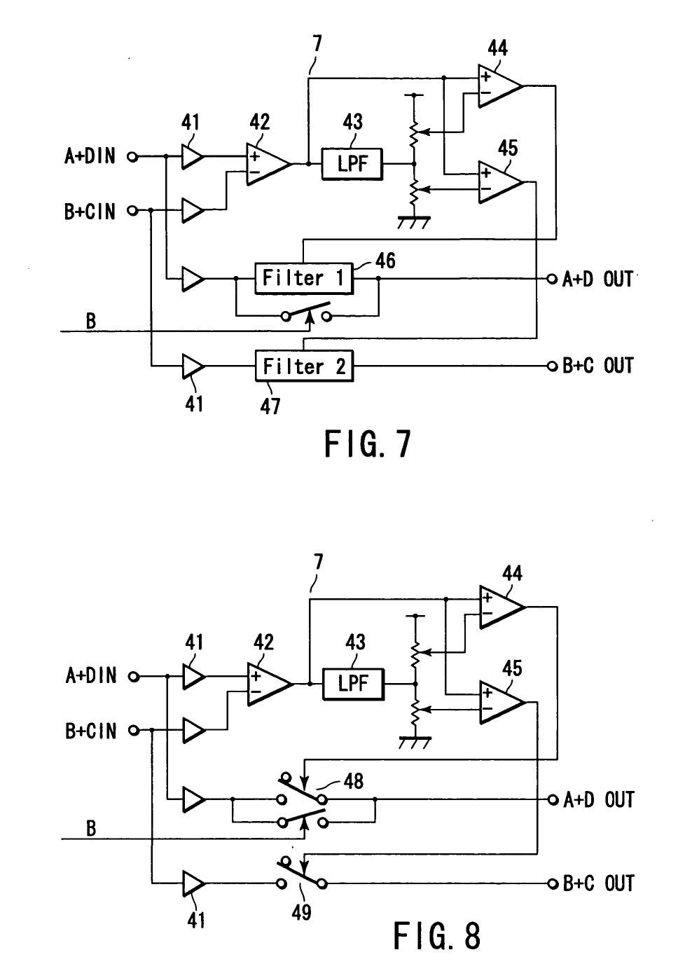

FIGS. 7 and 8 show embodiments compliant with both DVD-RAM and DVD-R or DVD-RW, where detracks are removed using filters in FIG. 7 or using switches in FIG. 8.

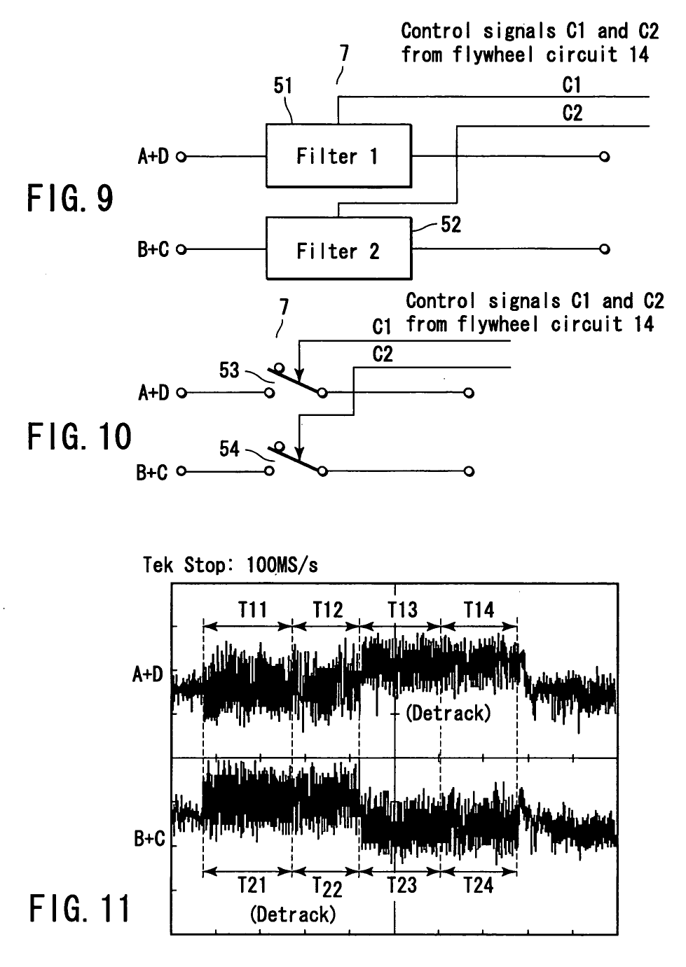

FIGS. 9 and 10 shows embodiments compliant with both DVD-RAM and DVD-R or DVD RW, where detracks are removed by control signals from the flywheel circuit 14 incorporated in the signal processing unit 4 using filters in FIG. 9 or using switches in FIG. 10.

(Detrack)

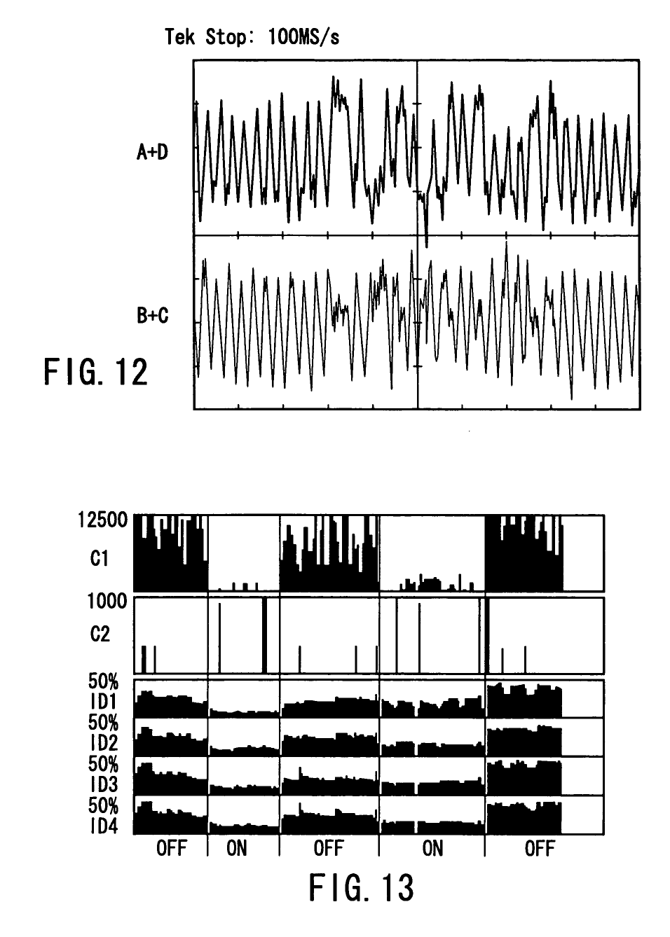

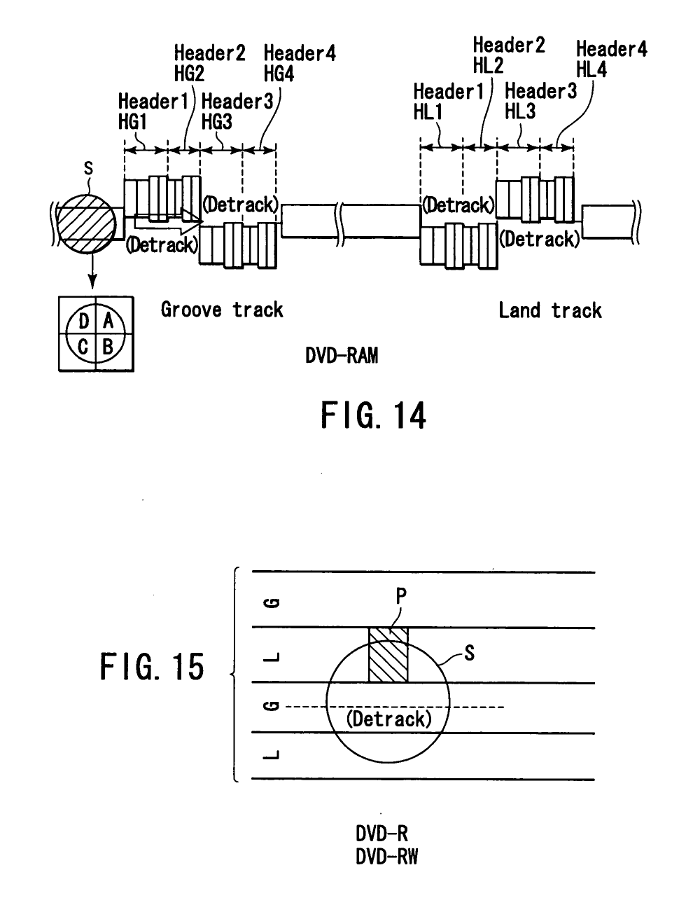

At first, a phenomenon of detrack which the detrack detecting/removing section 7 according to the present invention is to avoid will be described in detail with reference to the drawings. FIG. 11 is a diagram showing one example of detector outputs during CAPA passing of the optical disk device according to the present invention, FIG. 12 is an enlarged diagram of FIG. 11, FIG. 13 is a graph showing effects expressed by the detrack detecting/removing section according to the present invention, FIG. 14 is a diagram showing a CAPA configuration of a DVD-RAM disk where detracks are shown, and FIG. 15 is a diagram showing a prepit P of a DVD-R or DVD-RW disk where a detrack is similarly shown.

For example, when a reproducing processing of DVD-RAM is performed by the above optical disk device, as shown in FIG. 14, a spot S of a laser light emitted from the laser generator 37 is not necessarily at an optimal position relative to CAPA headers HG1 to HG4 in a groove track and CAPA headers HL1 to HL4 in a land track. In other words, the upper half of the beam S in the drawing is emitted on the header 1 HG1 and the header 2 HG2 and the lower half of the beam S is a detrack area where the header 1 HG1 and the header 2 HG2 are detracked so that a reflected light which is less influenced by a diffractive light directly emitted on the disk face is received by the quartered detector 34.

Namely, the detector section 34 which detects detection signals from reflected lights of laser lights emitted on a disk, the detection signals includes detrack components, which is failed to correctly detected by the detector section.

Therefore, in different words, a detection signal A and a detection signal D in the quartered detector 34 are based on reflected lights including normal address information included in the header 1 HG1 and the header 2 HG2, and a detection signal B and a detection signal C are based on reflected lights including error components (here, referred to as detrack components) where the address information on the header 1 HG1 and the header 2 HG2 are not sufficiently reflected. Since such detection signals including detrack components are together used for RF signal generation, the error components are mixed in the address information or the detection signals, which causes a binarizing failure or a malfunction of address recognition.

This phenomenon is identical to the case of the header 3 HG3 and the header 4 HG4 in the groove track, and identical to the cases of the header 1 HL1 and the header 2 HL2, and the header 3 HL3 and the header 4 HL4 in the land track except for the detrack positions.

However, when such detracks generate, since a relatively strong reflected light from the detrack area can be obtained as described above, the detection signals are monitored, respectively, so that detracks can be detected. In other words, FIG. 11 is a diagram showing one example of detection signals during CAPA passing, which indicate a detection signal A+D (upper stage) and a detection signal B+C (lower stage), where a potential is increased when the light amount is large. Since the detection signal expresses a high value in a period T₁₁ and a period T₁₂ in the detection signal B+C in this drawing, it can be seen that a detrack is generated. Similarly, since the detection signal expresses a high value in a period T₁₃ and in a period T₁₄, it can be seen that a detrack is generated. An optical disk reproducing device binarizes the detection signal to perform reading. But when a high potential is present in this manner, a response speed of a slice potential for binarizing is not in time, which may cause deterioration in an error rate.

Further, FIG. 12 is a diagram showing a portion of the header 1 HG1 (T₁l) in an enlarged manner. Since the detection signal B+C in the lower stage is detracked at this time, an influence caused by the diffractive light is small so that reproducibility in a short T (4T of VFO or the like) is good, but reproducibility in a long T (14T of AM or the like) is remarkably deteriorated. Therefore, it can be seen that the reading rate is deteriorated when an ID is read using a portion of this deteriorated reproducibility.

Further, FIG. 15 is a diagram for explaining a detrack in DVD-R or DVD-RW. In this drawing, the laser spot S is emitted along the center of the groove track. But, although the detection signal A+D receives a reflected light of the prepit P with respect to the prepit P in the land track, the detector of the detection signal B+C cannot receive the reflected light of the prepit P. The detrack detecting/removing section 7 according to the present invention is directed which detects and removing a detrack in such DVD-R or DVD-RW.

In order to eliminate an influence caused by such a detrack component, a detection signal from the detector which cannot detect CAPA (or prepit) is removed and is not supplied to the succeeding circuit so that such problem can be eliminated. Hereinafter, a specific circuit operation will be described in FIGS. 4 to 10.

(Description of detrack detecting/removing section)

FIGS. 3 and 4 shows embodiments compliant with DVD-RAM. In the detrack detecting/removing section 7 according to the present invention, as shown in FIG. 3, the detection signal A+D and the detection signal B+C supplied from the quartered detector 34 are given to an amplifier circuit 42 via each buffer 41 and an output thereof is supplied to a low pass filter 43. Further, an output of the low pass filter 43 is DC-shifted to an optimal potential. A waveform of the amplifier output and a DC-shifted waveform are supplied to a comparator 44 and a comparator 45, respectively, so that the comparator 44 outputs a detrack detection signal of the detection signal A+D and the comparator 45 outputs a detrack detection signal of the detection signal B+C.

The respective detection signals specify periods when detracks have generated in the respective detection signals. The detrack detection signals are supplied to a filter (1) 46 and a filter (2) 47, respectively, and unnecessary carriers of the detection signal A+D and the detection signal B+C are limited in bandwidth so that the detrack components are removed.

Thereby, the detrack detecting/removing section 7 according to the present invention detects detrack generation as described above and removes this detrack component so that a slice potential for binarizing is secured and address information from CAPA is secured, thereby improving the data reading rate.

Further, FIG. 4 has a configuration substantially similar to that in FIG. 3, where switches 48 and 49 are provided instead of the filter (1) 46 and the filter (2) 47 and appropriate predetermined potentials are connected to an input terminal of the detection signal A+D and an input terminal of the detection signal B+C instead of supplying the detection signals including the detrack components thereto according to given detrack detection signal so that the detrack components can be removed.

Alternatively, nothing is connected to the input terminal of the detection signal A+D and the input terminal of the detection signal B+C so that the detrack components are removed. Thereby, a similar removing processing can be performed with a simple configuration.

Further, FIGS. 5 and 6 show embodiments compliant with DVD-R or DVD-RW, which have configurations substantially similar to those in FIGS. 3 and 4, respectively, but which do not have the comparator 44 which has configuration for that and the filter (1) 46 (or the switch 48) since the detrack component from the detection signal A+D is not generated depending on a position of the prepit P. Thus, the detrack component generated due to the prepit P can be removed with respect to DVD-R or DVD-RW.

Further, FIGS. 7 and 8 have configurations compliant with both DVD-RAM and DVD-R or DVD-RW. The configurations in FIGS. 7 and 8 are substantially similar to those in FIGS. 3 and 4, but the filter (1) 46 or the switch 48 is bypassed according to a disk type identification signal B supplied from a disk type identifying section (not shown). In other words, when the disk is DVD-RAM, bypass is OFF such that the filter (1) 46 or the switch 48 functions as it is, and when the disk is DVD-R or DVD-RW, bypass is ON such that the filter (1) 46 or the switch 48 is bypassed. Thereby, the disk can be compliant with both DVD-RAM and DVD-R or DVD-RW.

FIGS. 9 and 10 show embodiments compliant with both DVD-RAM and DVD-R or DVD-RW. The embodiment in FIG. 9 has a filter (1) 51 and a filter (2) 52 driven by control signals C1 and C2 from the flywheel circuit 14, respectively, in order to eliminate the detracks by the control signals from the flywheel circuit 14 incorporated in the signal processing unit 4. Further, the embodiment in FIG. 10 has a switch 53 and a switch 54 driven by the control signals C1 and C2 from the flywheel circuit 14, respectively, and a function of the switches is similar to that in FIG. 4.

Here, the flywheel circuit 14 is directed for estimating a change in the succeeding detection signal on the basis of a change in a recording signal which records the RF signal amplified from the detection signal detected in the detector section 34 for a predetermined period. This flywheel circuit 14 monitors the RF signal to detect repeated signal changes. Thereby, the control signals C1 and C2 are generated by estimating detrack generation in each detection signal A+D, B+C and are supplied to the filter (1) 51 and the filter (2) 52, and the switch 53 and the switch 54.

Also in such a method, a detrack component which has failed to detect information on staggered CAPA, prepit, or the like, thereby improving reading accuracy.

Here, one example of the effects of the detrack detecting/removing section 7 according to the present invention can be confirmed in the graph of FIG. 13. In other words, the graph of FIG. 13 shows an error rate of C1 series, an error rate of C2 series, an ID reading rate of a header 1 HD1, an ID reading rate of a header 2 HD2, an ID reading rate of a header 3 HD3, and an ID reading rate of a header 4 HD4 in this order from the top of the graph. As the value is higher, the lower reading rate is indicated.

Here, the cases where the detrack detecting/removing section according to the present invention is ON/OFF are measured when DVD-RAM 2.6 GB is reproduced. As shown in the graph, it can be seen that an error rate of a rewritable area and an ID of CAPA are remarkably improved as compared with when the circuit is OFF.

(Description by Flow Chart)

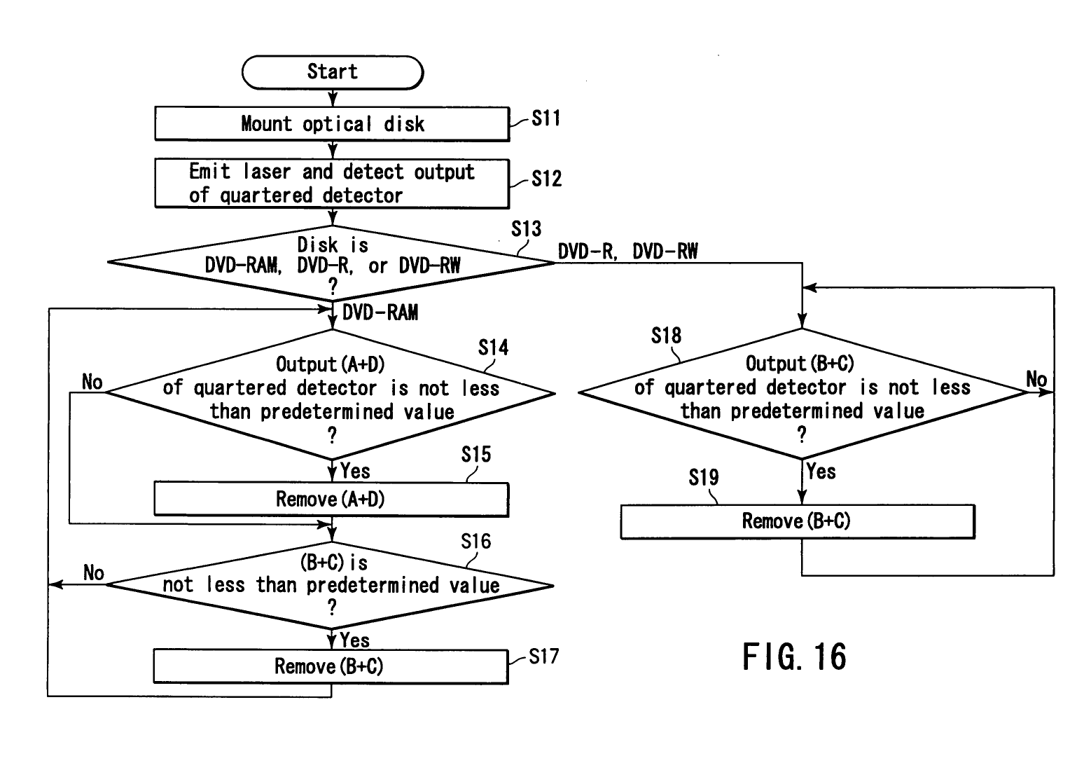

The detrack removing processing according to the present invention can be performed by a similar processing by a microcomputer and a computer program given thereto. Hereinafter, a description will be given using a flow chart in FIG. 16.

In this flow chart, the optical disk D is mounted at first (S11) to emit a laser light, and an output of the quartered detector is detected (S12). Next, a determination is made as to whether the disk is DVD-RAM or DVD-R or DVD-RW (S13).

When the disk is DVD-RAM, a determination is made as to whether or not the detection signal (A+D) in the quartered detector is not less than a predetermined value (S14). In the case of YES, it is determined that a detrack is present, so that the detection signal (A+D) is removed (S16). In the case of NO, a determination is made as to whether or not the detection signal (B+C) in the quartered detector is not less than a predetermined value (S16). In the case of YES, it is determined that a detrack is present, so that the detection signal (B+C) is removed (S17). Thereby, a detrack component of CAPA or the like is removed in DVD-RAM.

On the other hand, when it is determined in step S13 that the disk is DVD-R or DVD-RW, a determination is made as to whether or not the detection signal (B+C) in the quartered detector is not less than a predetermined value. In the case of YES, the detection signal (B+C) is removed (S19). Thereby, a detrack component of the prepit or the like can be removed in DVD-R or DVD-RW.

As described above, the present invention can be implemented by a microcomputer and a program thereof.

Those skilled in the art can realize the present invention by various embodiments described above, and further can easily invent various modifications of these embodiments and can apply them to various embodiments without inventive ability. Therefore, the present invention covers a wide range which is not contradictory to a disclosed principle and novel characteristics, and is not limited to the above embodiments.

As described above, according to the present invention, a signal change in a detection signal of an optical disk such as DVD-RAM, DVD-R, or DVD-RW is read so that a detrack component which has failed to detect information on staggered CAPA, prepit or the like is detected and removed and an error component of an address signal can also be removed without missing a duty in a comparator stage for binarizing, thereby providing an optical disk device and an optical disk processing method having improved reading accuracy.

What is claimed is:

1. A disk device comprising:
a detector section which detects detection signals from reflected lights of laser lights emitted on a disk, the detection signals includes detrack components, which is failed to correctly detected by the detector section;
a removing section which detects the detrack components, and removes the same from the detection signals; and
a processing section which applies a predetermined processing on the detection signals removed detrack components by the removing section.

2. A disk device according to claim 1, wherein the detection signals have a plurality of detection signals from a detector which is divided in plurality, and the removing section detects the detrack components on the basis of magnitude of potentials of the plurality of detection signals.

3. A disk device according to claim 1, wherein the detection signals have four detection signals from a quartered detector, and, when a differential signal between a sum of two signals at one side and a sum of two signals at the other side which are divided into two sides by a track axis of the disk exceeds a predetermined value, the removing section determines that detrack components which have failed to detect recording information on the disk are included in the detection signals, and removes the detrack components.

4. A disk device according to claim 1, wherein the removing section receives control signals supplied from a flywheel for estimating a change in a succeeding detection signal on the basis of a change in a recording signal which records RF signals amplified from detection signals detected by the detector section for a predetermined period, and removes detrack components of the detection signals according thereto.

5. A disk device according to claim 1, wherein the detection signals have four detection signals from a quartered detector which receives reflected lights from DVD (Digital Versatile Disk)-RAM (Random Access Memory), and, when a differential signal between a sum of two signals in a detector at one side and a sum of two signals in a detector at the other side which are divided into two sides by a track axis of the disk exceeds a predetermined value, the removing section determines that detrack components which have failed to detect the recording information are contained in the detection signals, and removes the detrack components by selecting at least one of the two signals in the detector at one side and the two signals in the detector at the other side according to the differential signal.

6. A disk device according to claim 1, wherein the detection signals have four detection signals from a quartered detector which receives reflected lights from DVD-R or DVD-RW, and, when a differential signal between a sum of two signals in a detector at one side and a sum of two signals in a detector at the other side which are divided into two sides by a track axis of the disk exceeds a predetermined value, the removing section determines that detrack components which have failed to detect the recording information are included in the detection signals, and removes at least one of the two signals in the detector at one side and the two signals in the detector at the other side.

7. A disk device according to claim 1, wherein the detection signals have four detection signals from a quartered detector which receives reflected lights from DVD-RAM, DVD-R, or DVD-RW,
the removing section determines that detrack components which have failed to detect the recording information are included in the detection signals when a differential signal between a sum of two signals in a detector at one side and a sum of two signals in a detector at the other side which are divided into two sides by a track axis of the disk exceeds a predetermined value, and
identifies a type of the disk, and selects and removes one of the two signals in the detector at one side and the two signals in the detector at the other side according to the differential signal when the disk is DVD-RAM, and
identifies a type of the disk, and removes at least one of the two signals in the detector at one side and the two signals in the detector at the other side when the disk is DVD-R or DVD-RW.

8. A disk device according to claim 1, wherein the removing section passes the detection signals through filters to output the same, and removes the detrack components.

9. A disk device according to claim 1, wherein the removing section removes the detrack components by giving predetermined potentials to input terminals of the processing section instead of supplying the detection signals thereto.

10. A disk device according to claim 1, wherein the removing section removes the detrack components in a state where the detection signals are not supplied to the input terminals of the processing section so that noting is connected thereto.

11. A disk processing method comprising:
detecting detection signals from reflected lights of laser lights emitted on a disk, the detection signals includes detrack components, which is failed to correctly detected by the detector section;
detecting the detrack components, and removing the same from the detection signals; and
applying a predetermined processing on the detection signals removed detrack components.

12. A disk processing method according to claim 11, wherein the detection signals have a plurality of detection signals from a detector which is divided in plurality, and the detrack components are detected on the basis of magnitude of potentials of the plurality of detection signals.

13. A disk processing method according to claim 11, wherein the detection signals have four detection signals from a quartered detector, and, when a differential signal between a sum of two signals in a detector at one side and a sum of two signals in a detector at the other side which are divided into two sides by a track axis of the disk exceeds a predetermined value, the step of removing determines that detrack components which have failed to detect recording information on the disk are included in the detection signals, and removes the detrack components.

14. A disk processing method according to claim 11, wherein the step of removing receives control signals supplied from a flywheel circuit for estimating a change in a succeeding detection signal on the basis of a change in a recording signal which records RF signals amplified from the detected detection signals for a predetermined period, and removes the detrack components of the detection signals according thereto.

15. A disk processing method according to claim 11, wherein the detection signals have four detection signals from a quartered detector which receives reflected lights from DVD (Digital Versatile Disk)-RAM (Random Access Memory), and, when a differential signal between a sum of two signals in a detector at one side and a sum of two signal in a detector at the other side which are divided into two sides by a track axis of the disk exceeds a predetermined value, the step of removing determines that detrack components which have failed to detect the recording information are contained in the detection signals, and selects and removes at least one of the two signals in the detector at one side and the two signals in the detector at the other side according to the differential signal.

16. A disk processing method according to claim 11, wherein the detection signals have four detection signals from a quartered detector which receives reflected lights from DVD-R or DVD-RW, and, when a differential signal between a sum of two signals in a detector at one side and a sum of two signals in a detector at the other side which are divided into two sides by a track axis of the disk exceeds a predetermined value, the step of removing determines that detrack components which have failed to detect the recording information are included in the detection signals, and removes at least one of the two signals in the detector at one side and the two signals in the detector at the other side.

17. A disk processing method according to claim 11, wherein the detection signals have four detection signals from a quartered detector which receives reflected lights from DVD-RAM, DVD-R, or DVD-RW, and
when a differential signal between a sum of two signals in a detector at one side and a sum of two signals in a detector at the other side which are divided into two sides by a track axis of the disk exceeds a predetermined value, the step of removing determines that detrack components which have failed to detect the recording information are included in the detection signals,
identifies a type of the disk, and selects and removes one of the two signals in the detector at one side and the two signals in the detector at the other side according to the differential signal when the disk is DVD-RAM, and
identifies a type of the disk, and removes at least one of the two signals in the detector at one side and the two signals in the detector at the other side when the disk is DVD-R or DVD-RW.

18. A disk processing method according to claim 11, wherein the step of removing passes the detection signals through filters to output the same, and removes the detrack components.

19. A disk processing method according to claim 11, wherein the step of removing removes the detrack components by giving predetermined potentials to input terminals of the processing section of the disk device instead of supplying the detection signals thereto.

20. A disk processing method according to claim 11, wherein the step of removing removes the detrack components in a state where the detection signals are not supplied to the input terminals of the processing section of the disk device so that nothing is connected thereto.
